(19) United States
(12) Patent Application Publication
(10) Pub. No.: US 2004/0007954 A1
(43) Pub. Date: Jan. 15, 2004

(54) Cathode ray tube

(76) Inventors: Sachio Koizumi, Mobara (JP); Toshifumi Komiya, Mobara (JP); Norio Iwamura, Mutsuzawa (JP)

Correspondence Address: Christopher E. Chalsen, Milbank, Tweed, Hadley & McCloy, LLP, One Chase Manhattan Plaza, New York, NY, 10005-1413, US

(21) Appl. No.: 10/457,342

(22) Filed: Jun. 9, 2003

(30) Foreign Application Priority Data
Jul. 14, 2002 (JP) 2002-173867

(51) Int. Cl. H01J 17/00

(52) U.S. Cl. 313/5

(57) ABSTRACT

The present invention realizes a cathode ray tube which holds the stable electron emission characteristics when the cathode ray tube is operated in a high current density state for a long time. An electron emissive material layer which constitutes a cathode is formed by dispersing a scandium compound having an average particle size of equal to or less than 1.2 μm to an oxide layer formed of alkaline earth metal (barium, strontium, calcium) oxide, wherein an atomic weight ratio of scandium with respect to strontium is set to a value within a range of 0.003 to 0.3. A base metal includes a reducing metal containing nickel as a main component and a plate thickness of a surface of a top portion of the base metal which comes into contact with the electron emissive layer is set to a value equal to or more than 0.17 mm.

### BACKGROUND OF THE INVENTION

1. Field of the Invention

The present invention relates to a cathode ray tube provided with a cathode having an electron emissive material layer, and more particularly, to a cathode ray tube which can hold the stable electron emission characteristics when the cathode ray tube is operated in a particularly high current density state for a long time and, at the same time, can realize high productivity by reducing a manufacturing cost through rationalization of manufacturing process.

2. Description of the Related Art

As this type of cathode ray tube, for example, a color cathode ray tube, an information terminal display cathode ray tube, a projection type cathode ray tube and the like have been known. In these cathode ray tubes, along with the diversification of information and the increase of density of information, high definition of images to be displayed on a display screen has been demanded. To satisfy such a demand, it is necessary to hold the stable electron emission characteristics even when the cathode ray tube is operated with high current density for a long time.

Many proposals have been already made with respect to cathode ray tubes having structures which satisfy the above-mentioned demand. As the typical structure, a structure described in unexamined published Japanese patent application No.321250/1996 can be named. Further, as other examples, cathode ray tubes which are described in unexamined published Japanese patent application No.288658/1999, unexamined published Japanese patent application No.357464/2000 and the like are exemplified.

For example, a color cathode ray tube served as a monitor for an OA equipment terminal includes an evacuated envelope which is constituted of a panel portion having a phosphor screen to which phosphors of three colors are applied, a neck portion housing an electron gun and a funnel portion which connects the panel portion and the neck portion. The electron gun which is served for the cathode ray tube having such a constitution includes a cathode which generates three electron beams which are arranged in the horizontal direction in parallel and a plurality of grid electrodes which are arranged along a tube axis. The electron beams emitted from the cathode pass through a main electron lens which is formed along an advancing direction of the electron beams and receive a given acceleration and a given focusing and, thereafter, are radiated toward the phosphor screen.

On the other hand, the phosphor screen is constituted such that phosphor pixels of three colors having either a dot shape or a stripe shape are arranged with a given arrangement pitch. Further, between the phosphor screen and the electron gun and also in the vicinity of the phosphor screen, a color selection mechanism such as a shadow mask, for example, is arranged.

The cathode which constitutes the electron gun of the above-mentioned cathode ray tube is configured such that an electron emissive material layer is formed on a surface of a top portion of a base metal by coating, and electrons are emitted from the electron emissive material layer by heating the base metal using a heater. As such an electron emissive material layer, there has been known an electron emissive material layer which is consisted of a plurality of layers, that is, which adopts a two-layered structure, for example. This structure exhibits proper high current operation characteristics and can prevent peeling off of the electron emissive material layer from the base metal. In this case, a first layer at the base metal side is constituted of oxide particles formed of coprecipitation crystal of alkaline earth metal (barium, strontium, calcium) and an upper layer, that is, a second layer is formed by dispersing 1 to 3 weight % of rare earth metal oxide into the alkaline earth metal oxide particles of the first layer.

As the above-mentioned rare earth metal oxide which constitutes the second layer, barium scandate (Ba₂Sc₂O₅, BaSc₂O₄, Ba₃Sc₄O₉) which is a composite oxide of barium and scandium is used. With respect to the electron emissive material layer which is constituted of this alkaline earth metal oxide (BaO, SrO, CaO) and the rare earth metal oxide which is dispersed in the alkaline earth metal oxide, the operational temperature is usually approximately 1000 k (727° Cb) at brightness temperature. A reducing agent in the base metal diffuses in a surface of the base metal of the cathode at this temperature and performs a reduction reaction with the alkaline earth metal oxide (BaO). Here, along with the increase of a plate thickness of the base metal, the reducing agent is diffused in the surface over a long time and, as a result, the life of the cathode is prolonged. The detail of these phenomena is disclosed in unexamined published Japanese patent application No.12983/1993, for example.

On the other hand, as the base metal of the cathode, a base metal which contains nickel as a main component and contains small quantities of silicon (Si), magnesium (Mg) and the like which constitute reducing elements is known. Properties of this base metal is related to a mechanism of electron emission from the cathode. Although various views are made with respect to this mechanism, in general, the reducing agent in the base metal forms free barium (Ba) by reducing barium oxide (BaO), the free barium is diffused in the electron emissive material layer, and a donor level is formed in the alkaline metal oxide and thereby the electron emission is performed.

Usually, the lifetime of emission is determined based on the consumption of the reducing agent in the base metal of the cathode and the evaporation of barium oxide (BaO) in the electron emissive material layer. However, with respect to the consumption of the reducing agent in the cathode base metal, the greater the plate thickness of the base metal, time necessary for diffusing the oxide barium is prolonged so that the life time of emission is prolonged. Accordingly, conventionally, the plate thickness follows the specification which has been used conventionally with respect to the rare earth metal distributed cathode and approximately 0.19 mm is favorably used. Further, although the evaporation of the oxide barium (BaO) in the electron emissive material layer is determined in response to the temperature of the electron emissive material layer, the consumption of the reducing agent in the base metal can be reduced due to an effect of dispersion of barium scandate. That is, since the free barium concentration of the electron emissive material layer is high, the reduction reaction of the oxide barium due to the reducing agent in the base metal can be suppressed and thereby the consumption of the reduction agent can be reduced.

### SUMMARY OF THE INVENTION

In the above-mentioned related art, the electron emissive material layer has the two-layered structure and the rare earth metal oxide is dispersed so that the sufficient consideration is paid with respect to the electron emission ability (high current operation characteristics) and the electron emission lifetime characteristics of the cathode. However, no consideration is paid to the enhancement of manufacturing yield rate of the cathode ray tube using the cathode and the enhancement of the productivity of the cathode ray tubes using the cathode obtained by the rationalization of the manufacturing step.

That is, the most important problem in the production of the cathode ray tube lies in a manufacturing cost incurred for holding the high degree of vacuum in the inside of the cathode ray tube for a long time. Particularly, in the initial stage that the cathode ray tube is completed, a gas emission quantity is large even after barium getters are sprayed in the inside of the cathode ray tube and hence, the electron emission characteristics are temporarily lowered. This lowering of the electron emission characteristics influences the manufacturing yield rate and the number of cathode ray tubes which are discarded as defective products is increased. As a result, a rate that a step for reproducing the electron emission characteristics becomes necessary is increased and thereby a burden applied to the manufacturing cost such as the increase of the number of process facilities is increased.

Further, what is most costly in the manufacture of the cathode ray tubes is to manufacture the cathode ray tubes in the atmosphere in which the high degree of vacuum is increased. To manufacture the cathode ray tubes in such an atmosphere, a degassing processing is performed while heating the cathode ray tubes. A sufficient care must be taken in setting conditions of this exhaust step. The exhaust step plays an extremely important role in the degassing processing in the inside of the cathode ray tubes. The temperature necessary for performing the degassing processing is set such that the temperature of the panel portion of the cathode ray tube can be held at least at approximately 340° C. In this manner, to hold the inside of the cathode ray tube in the high vacuum state while setting the cathode ray tube at the high temperature state, it is necessary to pay an attention to the breakage of the cathode ray tube. That is, when the elevation and lowering of temperature of the cathode ray tube are not properly and sufficiently performed, a joining portion between the panel portion and the funnel portion induces breakage due to an implosion in the inside of an exhaust furnace. Accordingly, for example, the temperature elevation and lowering processing is performed while spending a considerable time at a rate of approximately 4° C. per minute.

To properly perform the elevation and lowering of temperature while setting the inner temperature of the exhaust furnace at a high level, it is necessary to ensure enough time for holding the cathode ray tube in the inside of the exhaust furnace. This eventually lowers the productivity and pushes up the manufacturing cost. It is one of tasks of the present invention to solve such a drawback.

Accordingly, the present invention has been made to solve the above-mentioned drawbacks of the related art and it is an object of the present invention to provide a cathode ray tube which can hold the stable electron emission characteristics even when the cathode ray tube is operated in a high current density state for a long time and also can be manufactured at a low cost on a mass production basis by rationalizing the manufacturing step.

The cathode ray tube according to the present invention is a cathode ray tube which includes at least an evacuated envelope which is constituted of a panel portion having a phosphor screen on an inner surface thereof, a neck portion housing an electron gun and a funnel portion which connects the panel portion and the neck portion, wherein the electron gun includes a cathode having an electron emissive material layer on a surface of a top portion of a base metal. The cathode is configured to have a following constitution.

That is, with respect to the cathode which constitutes the electron gun of the cathode ray tube of the present invention, the electron emissive material layer is formed by containing and dispersing scandium compound powder which has an average particle size of equal to or less than 1.2 μm as measured by a laser diffraction method while having an atomic weight ratio of scandium with respect to strontium (scandium weight/strontium weight) in a range of the 0.003 to 0.3 in an alkaline earth metal oxide consisting of two components including at least strontium. Further, the above-mentioned base metal includes nickel as a main component and includes at least a reducing metal besides nickel. Further, a surface of the base metal which comes into contact with the electron emissive material layer has a plate thickness of equal to or more than 0.17 mm. Still further, the above-mentioned scandium compound is formed of scandium oxide or a composite oxide of barium and scandium.

In the cathode having such a constitution, by allowing the above-mentioned electron emissive material layer to contain the scandium compound having a small particle size, the evaporation of the free barium in the alkaline earth metal oxide layer can be suppressed and the free barium can be held at the high concentration state. Further, by increasing the plate thickness of the surface of the top portion of the base metal forming the electron emissive material layer, it is possible to prolong the diffusion distance of the reducing agent in the base metal.

Accordingly, even when the cathode ray tube is operated under the high current density state for a long time, it is possible to hold the stable electron emission characteristics. Further, since the manufacturing processing can be rationalized, it is possible to provide the cathode ray tube at a low cost on a mass production basis.

### BRIEF DESCRIPTION OF THE DRAWINGS

FIG. 1 is a cross-sectional view showing the constitution of a shadow mask type color cathode ray tube for explaining an embodiment of a cathode ray tube according to the present invention.

FIG. 2 is a plan view showing the constitution of an electron gun used in the cathode ray tube according to the present invention.

FIG. 3 is an enlarged cross-sectional view of an essential part of the electron gun shown in FIG. 2.

FIG. 4 is an enlarged cross-sectional view of an essential part showing the constitution of an electron gun of one embodiment of the cathode ray tube according to the present invention.

FIG. 5 is an enlarged cross-sectional view of an essential part showing the constitution of an electron gun of another embodiment of the cathode ray tube according to the present invention.

FIG. 6 is a cross-sectional view of another cathode ray tube to which the present invention is applied.

### DESCRIPTION OF THE PREFERRED EMBODIMENTS

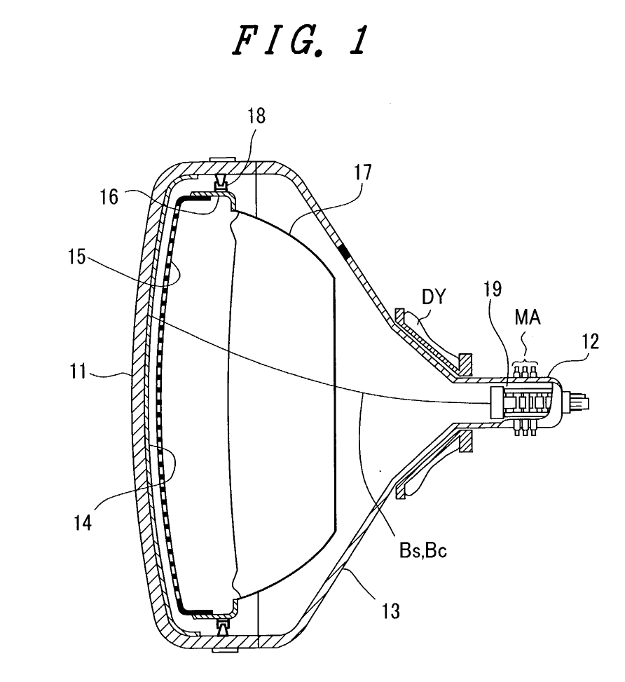

Preferred embodiments of the present invention are explained in detail in conjunction with drawings which show the embodiments. FIG. 1 is a cross-sectional view for explaining the whole structural example of a shadow mask type color cathode ray tube showing one embodiment of a cathode ray tube according to the present invention. In FIG. 1, numeral 11 indicates a panel portion, numeral 12 indicates a neck portion, numeral 13 indicates a funnel portion, numeral 14 indicates a phosphor screen, numeral 15 indicates a shadow mask having a large number of electron beam apertures, numeral 16 indicates a mask frame, numeral 17 indicates a magnetic shield, numeral 18 indicates a shadow mask suspension mechanism, numeral 19 indicates an electron guns which emits three electron beams consisting of a center electron beam Bc and two side beams Bs, symbol DY indicates a deflection yoke which deflects the electron beams horizontally as well as vertically and symbol MA indicates an external magnetic device which performs the purity correction or the like.

In this color cathode ray tube, an evacuated envelope is constituted as follows. That is, with respect to the panel portion 11 which includes the phosphor screen 14 on the inner surface thereof and the funnel portion 13, inside a bulb which is constituted of the panel portion 11 and the funnel portion 13, the mask frame 16 to which the shadow mask 15, the magnetic shield 17 and the like are fixed is suspended by the shadow mask suspending mechanism 18. Then, the panel portion 11 and the funnel portion 13 are fixed to each other by welding using frit glass. Thereafter, the electron gun 19 is filled in the inside of the neck portion 12 and the inside of the neck portion 12 is sealed in vacuum.

In such a constitution, three electron beams which are irradiated from the electron gun 19 housed in the neck portion 12 receive deflection in two directions, that is, the horizontal direction and the vertical direction, by the deflection yoke DY which is exteriorly mounted on a transitional portion between the neck portion 12 and the funnel portion 13. Then, the electron beams pass through electron beam apertures formed in the shadow mask 15 which constitutes a color selection mechanism and impinge on phosphor pixels of given colors which constitute the phosphor screen 14 thus forming an image.

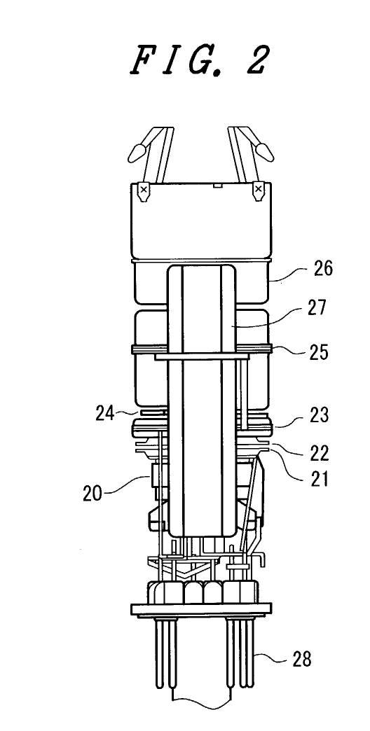

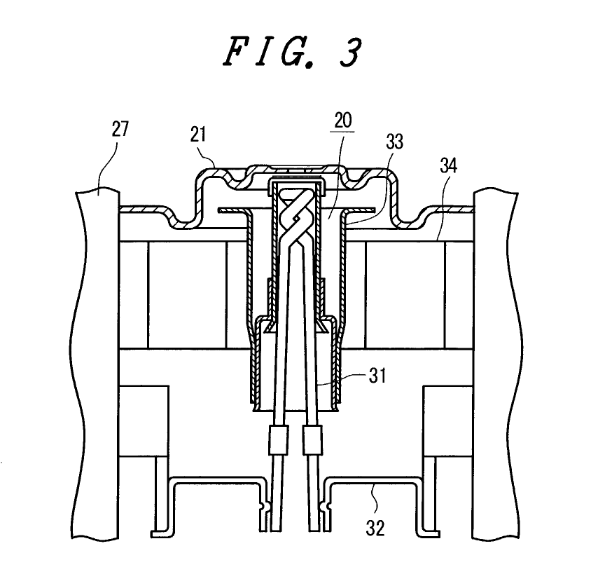

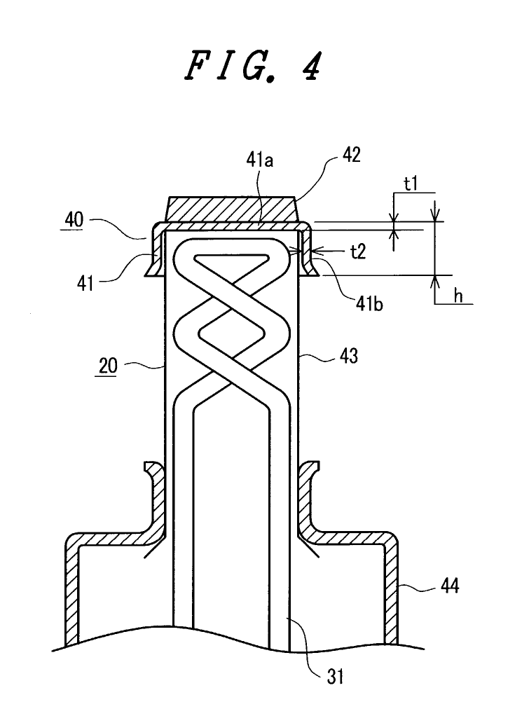

FIG. 2 is a plan view for explaining the constitution of the electron gun used in the cathode ray tube according to the present invention. In FIG. 2, numeral 20 indicates a cathode structure. One example of the cathode structure 20 is shown in FIG. 3 and FIG. 4. Numeral 21 indicates a first electrode (control electrode), numeral 22 indicates a second electrode (acceleration electrode), numerals 23, 24 and 25 indicate a third electrode, a fourth electrode and a fifth electrode (focusing electrode) respectively, numeral 26 indicates a sixth electrode (anode), numeral 27 indicates a multiform glass, numeral 28 indicates stem pins. Further, the cathode structure 20 and respective electrodes up to the sixth electrode 26 are coaxially supported and fixed by a pair of multi-form glasses 27 by embedding electrode support lugs thereof into the multi-form glass 27.

In such a constitution, the electron beams which are irradiated from the cathode structure 20 receive given acceleration and focusing by the first electrode 21, the second electrode 22, the third electrode 23, the fourth electrode 24, the fifth electrode 25 and the sixth electrode 26 and are radiated in the direction toward the phosphor surface 14 from the sixth electrode 26. Here, the stem pins 28 are terminals for applying required voltages and video signals to given electrodes which constitute the electron gun 19.

FIG. 3 is an enlarged cross-sectional view of an essential part in FIG. 2. In FIG. 3, the cathode structure 20 arranges a heater 31 in the inside thereof and the heater 31 has a lower end thereof fixedly mounted on a heater support 32. Numeral 33 indicates a cathode eyelet. The cathode eyelet 33 holds the cathode structure 20 by a lower end thereof and is also fixedly mounted on a cathode supporting bead support 34 and thereby the cathode structure 20 is fixed to a given position of the electron gun.

FIG. 4 is an enlarged cross-sectional view of an essential part in FIG. 3. In FIG. 4, numeral 40 indicates a cathode. The cathode 40 is constituted of a cup-shaped base metal 41 and an electron emissive material layer 42 which is formed on a top portion 41a of the base metal 41. Numeral 43 indicates a cylindrical cathode sleeve. The cathode sleeve 43 has one end thereof fixed to a side wall 41b of the base metal 41 of the cathode 40 and another end fixed to a cathode disc 44. That is, the cathode structure 20 is constituted of the cathode 40, the cathode sleeve 43 and the cathode disc 44.

The above-mentioned base metal 41 is formed of a metal material which contains nickel (Ni) as a main component and also includes a small amount of reducing metal such as silicon (Si) or magnesium (Mg) therein. The base metal 41 is substantially formed in a cup shape. Further, a plate thickness t1 of a portion of the top portion 41a of the base metal 41 to which the electron emissive material layer 42 is applied is set to approximately 0.185 mm in this embodiment. Further, a height h of the side wall 41b of the base metal 41 is set to approximately 0.7 mm, for example, and a plate thickness t2 is set to approximately 0.05 mm, for example. Here, in view of productivity of press working, it is preferable to set the relationship between the plate thickness t1 and the plate thickness t2 to a value which falls within a range of t2/t1=⅕ to ⅗. It is possible to increase the plate thickness t1 by decreasing this ratio and hence, the consumption time during which the reducing agent such as silicon, magnesium in the base metal 41 diffuses into the top portion 41a of the base metal 41 which constitutes a surface for forming the electron emissive material layer 42 can be prolonged and thereby the electron emission lifetime characteristics can be largely enhanced.

Here, the cup-shaped base metal 41 is fitted on and fixed to one end of the cathode sleeve 43 so as to seal one end of the cathode sleeve 43. Another end of the cylindrical cathode sleeve 43 is fixed to the cathode disc 44 by usual laser welding. That is, another end side of the cylindrical cathode sleeve 43 is fixed to the cathode disc 44 by laser welding and the heater 31 is housed in the cylindrical cathode sleeve 43 so as to heat the cathode 40.

The electron emissive material layer 42 is formed by dispersing the oxide scandium (Sc₂O₃), for example, as the scandium compound into the oxide layer formed of alkaline earth metal (barium, strontium, calcium) oxide such that the atomic weight ratio of the scandium with respect to strontium becomes approximately 0.03. In this case, the electron emissive material layer 42 is formed of carbonate of barium.strontium.calcium [(Ba.Sr.Ca)CO₃] into which scandium oxide (Sc₂O₃) is dispersed and is formed by applying the carbonate to the surface of the top portion 41a of the base metal 41.

The electron emissive material 42 is produced by a method explained hereinafter. First of all, to a mixture solution of 53% by weight of barium nitrate (BaNO₃), 38% by weight of strontium nitrate (SrNO₃) and 6% by weight of calcium nitrate (CaNO₃), sodium carbonate (Na₂CO₃) is added so as to precipitate the carbonate of barium.strontium.calcium [(Ba.Sr.Ca)CO₃] and thereby the powdery precipitate is produced.

In this embodiment, a shape of particles of the carbonate of barium.strontium.calcium [(Ba.Sr.Ca)CO₃] is needle crystals having an average particle size of approximately 15 μm as measured by a laser diffraction particle size distribution measuring method.

Then, approximately 1% by weight of scandium oxide (Sc₂O₃) having an average particle size of approximately 0.5 μm as measured by a laser diffraction particle size distribution measuring method is mixed into the powdery precipitate. Suitable amounts of nitrocellulose lacquer and butyl acetate are added to the mixture and rolling mixing is performed to prepare a suspension. In this embodiment, approximately 1% by weight of scandium oxide (Sc₂O₃) is mixed into the powdery precipitate which is in the state of carbonate of barium.strontium.calcium [(Ba.Sr.Ca)CO₃] so that the suspension in which the atomic weight ratio of the scandium with respect to strontium being approximately 0.03 is obtained. Here, the shape of particles of dispersed scandium oxide (Sc₂O₃) is prepared by pulverization and has an arbitrary polygonal shape.

Next, this suspension is applied by a spray method to the top portion 41a of the cup-shaped base metal 41 which contains nickel as the main component and and thereby the electron emissive material layer 42 having a thickness of an approximately 70 μm is formed.

Then, in a vacuum exhaust step of the cathode ray tube, the electron emissive material layer 42 is heated by a heater 31 so as to thermally decompose carbonate of barium.strontium.calcium [(Ba.Sr.Ca)CO₃] in the electron emissive material layer 42. Due to this thermal decomposition, oxide of barium.strontium.calcium [(Ba.Sr.Ca)O] is produced. Thereafter, oxide of barium.strontium.calcium [(Ba.Sr.Ca)O] is heated in the atmosphere of 900° C. to 1100° C. to perform activation and aging processing and and thereby the given cathode 40 is formed.

The brightness temperature of an electron emitting surface of the electron emissive material layer 42 formed in the above-mentioned manner is approximately 750° Cb. This brightness temperature of the electron emitting surface is measured from the direction of the shield cup side after performing the activation and the aging processing of the electron gun 19 in a bell jar, for example. Further, independently from the cathode ray tube, only the electron gun 19 is sealed in a glass tube and the brightness temperature of the electron emitting surface may be measured from the direction of the shield cup side after performing the activation and the aging processing. Here, the brightness temperature of approximately 750° Cb of the electron emitting surface is a brightness temperature measured by a pilot meter and a true temperature (operational temperature) which takes the electron emission rate of the electron emissive material layer into consideration is approximately 800° C.

Due to the provision of the cathode having the electron emissive material layer 42 formed in the above-mentioned manner, in the electron emissive material layer 42 formed of barium.strontium.calcium oxide in which scandium oxide (Sc₂O₃) is dispersed, the free barium (Ba) which is liable to be easily evaporated is constrained by scandium oxide (Sc₂O₃) and hence, the free barium (Ba) in the inside of the electron emissive material layer 42 can be held in a highly concentrated state and thereby even when the cathode operational temperature is high, it is possible to obtain the favorable electron emission characteristics and, at the same time, it is possible to obtain the excellent high current density operational characteristics.

Particularly, this advantageous effect is substantially proportional to a total surface area of scandium oxide (Sc₂O₃) which is dispersed in the inside of the electron emissive material layer 42. When the average particle size falls in a range of 0.2 to 1.0 μm, the evaporation suppression effect of the free barium (Ba) becomes remarkable and hence, it is possible to set the cathode operational temperature to a high level.

Further, in the above-mentioned embodiment, the explanation is made with respect to the case in which a content of scandium oxide (Sc₂O₃) is set to approximately 0.03 as the weight ratio with strontium (weight of scandium/weight of strontium). However, the present invention is not limited to such a value. On the other hand, when a content of scandium oxide is set to less than 0.03 as the weight ratio with strontium, sufficient electron emission lifetime characteristics cannot be obtained at the time of using the cathode by setting the high operational temperature of the cathode.

When a content of scandium oxide exceeds 0.03 as the weight ratio with strontium, the scandium oxide does not perform the electron emission, does not contribute to the electric conduction in the inside of the electron emissive material layer, and impedes the electron emission characteristics. Accordingly, by suitably selecting a content of scandium oxide as the weight ratio with strontium within a range of 0.003 to 0.3, it is possible to obtain similar advantageous effects as the previously-mentioned case.

According to a result obtained by studying various experiments which are repeatedly performed by inventors of the present invention, it is confirmed that an optimum advantageous effect can be obtained by setting a content of scandium oxide as the weight ratio with strontium within a range of 0.014 to 0.09.

Further, although the explanation is made with respect to the case in which the plate thickness of the top portion 41a of the base metal 41 is set to approximately 0.185 mm in the previously-mentioned embodiment, when the plate thickness is set to less than 0.17 mm, it is impossible to obtain the cathode structure having high productivity which has high durability against a residual gas even when the operational temperature of the cathode is elevated. That is, it is impossible to obtain the required electron emission lifetime characteristics (for approximately 10 years when operated 7 hours/day) even with the improvement of the electron emissive material layer 42. Further, corresponding to the increase of the plate thickness of the top portion 41a of the base metal 41 which is equal to or more than 0.17 mm, the more excellent effect can be obtained. However, to the contrary, a heat capacity is increased so that an image outputting time is delayed. Accordingly, to take the easy realization of practical use as an industrial product and the enhancement of the productivity into consideration while holding the high electron emissive lifetime characteristics obtained by the improvement of the electron emissive material layer 42, the maximum allowable plate thickness is limited to approximately 0.3 mm.

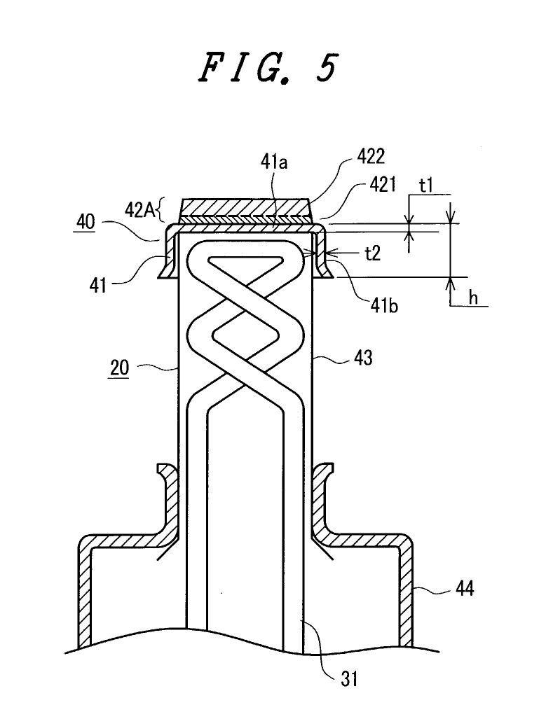

FIG. 5 is an enlarged cross-sectional view of an essential part of an electron gun having the constitution of another embodiment of the cathode ray tube according to the present invention. Parts identical with the parts shown in FIG. 4 are given same symbols and their explanation is omitted. The constitution which makes FIG. 5 different from FIG. 4 lies in that an electron emissive matrial layer 42A adopts the two-layered structure which is constituted of a first layer 421 made of alkaline earth metal (barium, strontium, calcium) oxide and a second layer 422 which is formed by dispersing scandium oxide (Sc₂O₃) into alkaline earth metal (barium, strontium, calcium) oxide consisting of two components containing at least strontium such that the atomic weight ratio of scandium with respect to strontium assumes approximately 0.03. Further, the constitution which makes FIG. 5 different from FIG. 4 also lies in that the first layer 421 is formed on a surface of the top portion 41a of the base metal 41 by lamination and the second layer 422 is laminated to the first layer 421.

Next, the manufacture of the above-mentioned electron emissive material layer 42A is explained. First of all, the above-mentioned first layer formed of the alkaline earth metal carbonate and having a thickness of approximately 15 μm is formed on the surface of the top portion of the base metal 41 by applying the carbonate using a spray method. Then, the above-mentioned second layer formed of alkaline earth metal carbonate in which scandium oxide (Sc₂O₃) is dispersed and having a thickness of approximately 45 μm is formed on the first layer by applying the carbonate using a spray method. Then, by making use of heat added at the time of performing heat treatment in a vacuum exhaust processing of the cathode ray tube, the alkaline earth metal carbonate in the first layer and the second layer is thermally decomposed thus changing them to alkali earth metal oxides respectively and thereby the first layer 421 and the second layer 422 of the electron emissive material layer 42A are simultaneously formed.

In such a constitution, by making the electron emissive material layer 42A have the two-layered structure which is constituted of the first layer 421 and the second layer 422 in which scandium oxide is dispersed, a content of scandium oxide(Sc₂O₃) falls in a range of 0.3 to 3.0 in the weight ratio with respect to strontium contained in the whole electron emissive material layer 42A. This content is substantially equal to the range of 0.03 to 0.3 which is the weight ratio of scandium oxide(Sc₂O₃) with respect to strontium dispersed in the electron emissive material layer formed of a single layer of the previously-mentioned embodiment and hence, the advantageous effects which are completely identical with those of the previously-mentioned embodiment can be obtained.

In the above-mentioned embodiment, the explanation is made with respect to the case in which the electron emissive material layer 42A is formed of the two-layered structure consisting of the first layer 421 and the second layer 422. However, the present invention is not limited to such a case and the substantially same advantageous effect can be obtained by constituting the electron emissive material layer 42A having the multi-layered structure which is formed by alternately laminating the first layer 421 and the second layer 422 in plural layers.

Further, in the above-mentioned embodiment, the explanation is made with respect to the case in which scandium oxide is used as the scandium compound. However, the present invention is not limited to such a case and even when a composite oxide formed of scandium and barium is used in place of scandium oxide, the advantageous effects which are completely identical with those of the previously-mentioned embodiment can be obtained.

Further, in the above-mentioned embodiment, the explanation is made with respect to the case in which a content of dispersed scandium oxide (Sc₂O₃) is approximately 0.03 in the atomic weight ratio with respect to strontium (weight of scandium/weight of strontium). However, it is needless to say that the present invention is not limited to such a case and provided that the content falls within a range of 0.03 to 0.3 in the atomic weight ratio with respect to strontium, by suitably selecting the content, the substantially same advantageous effects as those of the previous embodiments can be obtained.

Further, in the above-mentioned embodiment, the explanation is made with respect to the case in which the cathode ray tube is applied to the color cathode ray tube. However, it is needless to say that the present invention is not limited to such a case and the substantially same advantageous effects as those of the previous embodiments can be obtained by applying the cathode ray tube to an information terminal display cathode ray tube, a projection type cathode ray tube and the like.

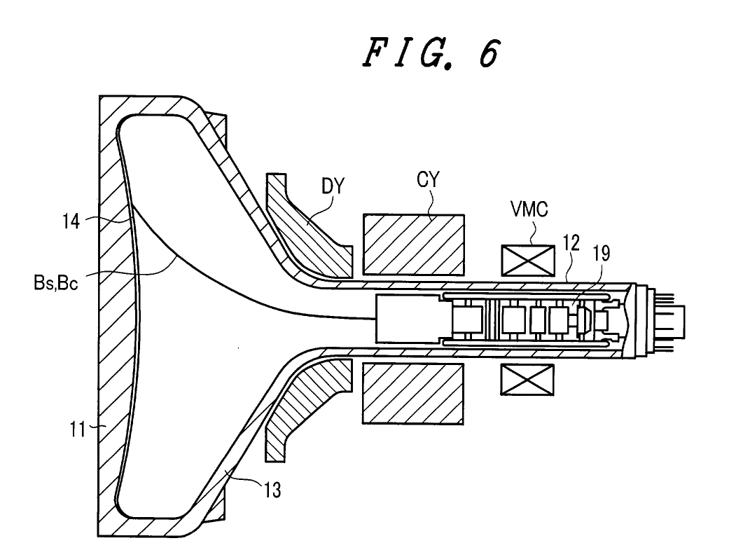

FIG. 6 is a cross-sectional view of another cathode ray tube to which the present invention is applied. This cathode ray tube is a monochromatic projection type cathode ray tube. Parts identical with the parts shown in FIG. 1 are given same numerals. The projection type cathode ray tube constitutes an evacuated envelope by a panel portion 11 which forms a phosphor screen 14 on an inner surface thereof, a neck portion 12 which houses an electron gun 19 and a funnel portion 13 which connects the panel portion 11 and the neck portion 12. The phosphor screen 14is formed of a monochromatic phosphor layer. On the evacuated envelope, a deflection yoke DY, a correction magnetic device CY which corrects a locus of an electron beam and a velocity modulation coil VMC are exteriorly mounted. The deflection yoke DY is exteriorly mounted on a transitional region between the neck portion 12 and the funnel portion 13. The velocity modulation coil VMC and the correction magnetic device CY for adjusting convergence are exteriorly mounted on an outer periphery of the neck portion 12. These magnetic field generating devices are arranged in order of the deflection yoke DY, the correction magnetic device CY and the velocity modulation coil VMC from the phosphor screen side.

The present invention is not limited to the constitutions described in claims and the constitutions described in the embodiments and it is needless to say that various modifications are considered without departing from the technical concept of the present invention.

As has been described heretofore, according to the present invention, by dispersing the scandium compound which has the average particle size of equal to or less than 1.2 μm and has the atomic weight ratio thereof with respect to strontium set to a value within a range of 0.003 to 0.3 into the alkaline earth metal oxide, the evaporation of the free barium from the electron emissive material layer can be suppressed so that the free barium is held in the highly concentrated state and thereby the excellent high current density operational characteristics can be obtained. That is, since the cathode ray tube hardly receives influence attributed to the residual gas, the yield rate of the electron emissive characteristics can be enhanced. Accordingly, the exhaust step is largely rationalized including lowering of the exhaust temperature in the exhaust step (shortening of the period for the exhaust step and the enhancement of the indexing) thus giving rise to an extremely excellent advantageous effect that a manufacturing cost of the cathode ray tubes can be largely reduced.

Further, according to the present invention, since the high current density operational characteristics can be obtained, even when the operational temperature of the cathode is elevated, the favorable electron emission characteristics can be obtained. Accordingly, it is possible to realize the reduction of manufacturing cost of the cathodes by rationalization of the exhaust step such as lowering of the heating temperature and heating time in the exhaust step and hence, it is possible to obtain the extremely excellent advantageous effect that the manufacturing cost of the cathode ray tube can be largely reduced.

Still further, according to the present invention, it is possible to obtain the high current density operational characteristics. Accordingly, although there exists some problem with respect to the lifetime characteristics, by setting the plate thickness of the surface of the top portion of the base metal which comes into contact with the electron emissive material layer to a value equal to or less than 0.17 mm, the diffusion distance of the reducing agent can be prolonged and hence, it is possible to obtain the favorable electron emission characteristics in the state that the cathode is operated at the high temperature and it is also possible to obtain the high current operational characteristics. Accordingly, it is possible to obtain the extremely excellent advantageous effects that the brightness characteristics and the focusing characteristics of the phosphor screen can be largely enhanced and the bright screen can be realized even when the cathode ray tube is applied to a large-sized display monitor.

What is claimed is:

1. A cathode ray tube including an evacuated envelope which is constituted of a panel portion having a phosphor screen on an inner surface thereof, a neck portion housing an electron gun and a funnel portion connecting the panel portion and the neck portion, the electron gun including a cathode having an electron emissive material layer on a top portion of a base metal, wherein
the electron emissive material layer contains and disperses a scandium compound which has an average particle size of equal to or less than 1.2 μm as measured by a laser diffraction method while having an atomic weight ratio of scandium with respect to strontium in a range of the 0.003 to 0.3 in an alkaline earth metal oxide containing strontium,
the base metal includes nickel as a main component and also includes a reducing metal besides nickel, and the top portion of the base metal has a plate thickness of equal to or more than 0.17 mm.

2. A cathode ray tube according to claim 1, wherein the scandium compound is formed of scandium oxide or a composite oxide of barium and scandium.

3. A cathode ray tube according to claim 1, wherein the electron emissive material layer has a two-layered structure.
